(19) United States
(12) Patent Application Publication
(10) Pub. No.: US 2013/0242008 A1
(43) Pub. Date: Sep. 19, 2013

(54) INK SUPPLY HAVING MEMBRANE FOR VENTING AIR

(71) Applicant: BRIAN J. KWARTA, Pittsford, NY (US)

(72) Inventor: BRIAN J. KWARTA, Pittsford, NY (US)

(21) Appl. No.: 13/421,987

(22) Filed: Mar. 16, 2012

(51) Int. Cl. B41J 2/175; B01D 19/00

(52) U.S. Cl. 347/86; 96/6

(57) ABSTRACT

An apparatus for passing a liquid from a first location to a second location, the apparatus includes a conduit having an inlet for receiving the liquid from the first location; an outlet for passing the liquid to the second location; and a vent for permitting gas to be vented; a membrane disposed covering the vent for permitting the venting of gas but not the passage of the liquid; and a movable element disposed in the conduit for selectively permitting and inhibiting flow of gas to the vent, wherein when liquid in the conduit is below a predetermined threshold, the movable device is placed at a venting position that allows free flow of gas to the membrane, and when the liquid in the conduit is at or above the predetermined threshold, the movable device is placed at a sealing position that does not allow free flow of liquid to the membrane.

### CROSS REFERENCE TO RELATED APPLICATIONS

Reference is made to commonly assigned U.S. patent application Ser. No. ______ (Docket K000937) filed concurrently herewith by Brian Kwarta, entitled “Method for Venting Air with a Membrane,” the disclosure of which is herein incorporated by reference.

### FIELD OF THE INVENTION

The present invention generally relates to off-axis inkjet printers having a vent covered with a membrane for venting air out of tubing between a primary ink supply and a secondary ink supply and more particular to an apparatus for venting the air while eliminating degradation of the performance of the membrane due to wetting by ink and to eliminate moisture loss effecting ink concentration and thus system performance.

### BACKGROUND OF THE INVENTION

In many types of fluidic systems a liquid is transferred from one location to another location, and air can sometimes get into the passageways through which liquid is transferred. This can degrade the ability to transfer liquid and even the performance of the system in some instances. A vent is typically provided in such systems for removing air when needed, and in some instances, an air permeable membrane is included in the vent path. Such a membrane allows air to pass through it, but does not allow the particular liquid to pass through it. The membrane can also keep particulates or other contaminants from entering the fluidic system.

An example of a fluidic system employing liquid transfer is an inkjet printer having a primary ink supply and a secondary ink supply. In a carriage printing system, for example, (whether for desktop printers, large area plotters, etc.) the printhead or printheads are mounted on a carriage that is moved back and forth past the recording medium in a carriage scan direction as the inkjet nozzles eject droplets of ink to make a swath of dots. At the end of the swath, the carriage is stopped; printing is temporarily halted and the recording medium is advanced. Then another swath is printed so that the image is formed swath by swath. The amount of ink that is stored on the carriage is typically sufficient for printing several hundred documents. For some inkjet carriage printers the nominal usage is on the order of a couple thousand pages per year. In such cases, having replaceable ink tanks on the carriage is a good approach. However, for printing systems that have heavier usage, that typically print high density ink coverage, or that print wide format documents, a better approach is to have a primary ink supply that is stationarily mounted on the printer, and a secondary ink supply that is mounted on the carriage. Ink is transferred from the primary ink supply to the secondary ink supply as needed. In this way, the amount of ink that is moved by the carriage is kept low (so that forces during carriage acceleration and deceleration can be acceptably low) and the user does not need to replace the ink very frequently.

To refill the secondary ink supply from the primary ink supply, flexible tubing is used, or alternatively the secondary ink supply can be moved near the primary ink supply on an as-needed basis and ink can be transferred through a needle and septum for example. In any case, sometimes air can get into the passageways between the primary ink supply and the secondary ink supply. For example, when the system is new, the passageways are full of air that needs to be removed for effective ink transfer. A vent is typically provided near the secondary ink supply so that air can be vented out as ink is transferred into the passageways. At other times during the life of the printer, air can also get into the fluid passageways such as during changing the printhead or the primary ink supply.

There are shortcomings that can occur in a conventional air vent in a liquid transfer system. First of all, volatile components of the ink can escape through the vent. For the aqueous based inks that are typically used in inkjet printers, water is typically a major component. Other ink components typically include colorants, humectants, surfactants, and sometimes polymers. The water is typically the least viscous component and the most volatile. As the water evaporates, the water vapor can escape through the air permeable membrane. As more moisture evaporates, the remaining ink becomes more viscous, which can affect the jetting performance. A second shortcoming that can occur is that if the ink is allowed to contact the air permeable membrane, it can obstruct the pores so that the ability of the air permeable membrane to let air through it is degraded.

Consequently, a need exists for a venting configuration that inhibits the escape of vapor from the volatile components of the liquid and that also inhibits the liquid from wetting the air permeable membrane.

### SUMMARY OF THE INVENTION

The present invention is directed to overcoming one or more of the problems set forth above. Briefly summarized, according to one aspect of the invention, the invention resides in an apparatus for passing a liquid from a first location to a second location, the apparatus includes a conduit having an inlet for receiving the liquid from the first location; and an outlet for passing the liquid to the second location; and a vent for permitting gas to be vented; a membrane disposed covering the vent for permitting the venting of gas but not the passage of the liquid; and a movable element disposed in the conduit for selectively permitting and inhibiting flow of gas to the vent, wherein when liquid in the conduit is below a predetermined threshold, the movable device is placed at a venting position that allows free flow of gas to the membrane, and when the liquid in the conduit is at or above the predetermined threshold, the movable device is placed at a sealing position that does not allow free flow of liquid to the membrane. The combination and relationship of these two components remove the burdens of failure modes associated with designs incorporating only one of either device. That is, the overall cost will decrease and the reliability increases when incorporating both components as opposed to the engineering needed to ensure robustness if either of the two are used singularly.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a perspective of an off-axis printing system of the present invention;

FIG. 2 is a schematic of the of the ink transfer device of the present invention illustrating ink in the flexible tubing;

FIG. 3 is a schematic of the of the ink transfer device of the present invention illustrating air in the flexible tubing;

FIG. 4 is a perspective of an ink transfer device of the present invention;

FIG. 5a is cross-sectional view of the ink transfer device of FIG. 4;

FIG. 5b is a cross sectional view of FIG. 5 taken along line 5b;

FIG. 5c is a cross sectional view of FIG. 5 taken along line 5c;

FIG. 6 is a perspective of the ink transfer device of FIG. 5 with the conduit removed;

FIG. 7 is a perspective of the ink transfer device of FIG. 5 with the conduit and ball float removed;

FIG. 8 is a perspective of the ink transfer device of FIG. 5 with the conduit, vent cap and air membrane removed;

FIG. 9 is a perspective of the ink transfer device of FIG. 5 with the conduit and vent cap removed;

FIG. 10 is a perspective view of a plurality of ink interfaces of the present invention; and

FIG. 11 is a schematic view of the present invention illustrating a pump used for pumping ink.

While the specification concludes with claims particularly pointing out and distinctly claiming the subject matter of the present invention, it is believed that the invention will be better understood from the following description when taken in conjunction with the accompanying drawings.

### DETAILED DESCRIPTION OF THE INVENTION

As used herein, words such as “upwardly,” “downwardly,” and the like are words of convenience for the position shown in the particular figure, but as easily understood by those skilled in the art, such directional terms are altered when the particular orientation is correspondingly altered. Also in the embodiment of an inkjet printer, air is typically the gas of interest that is being vented, but it is understood that, in the event that the environment contains some other gaseous element or used in an industrial environment application with other gases, such other gas also be vented. Therefore, the term gas as used herein can be either air, air plus one or more other gaseous elements, or some gaseous element without air.

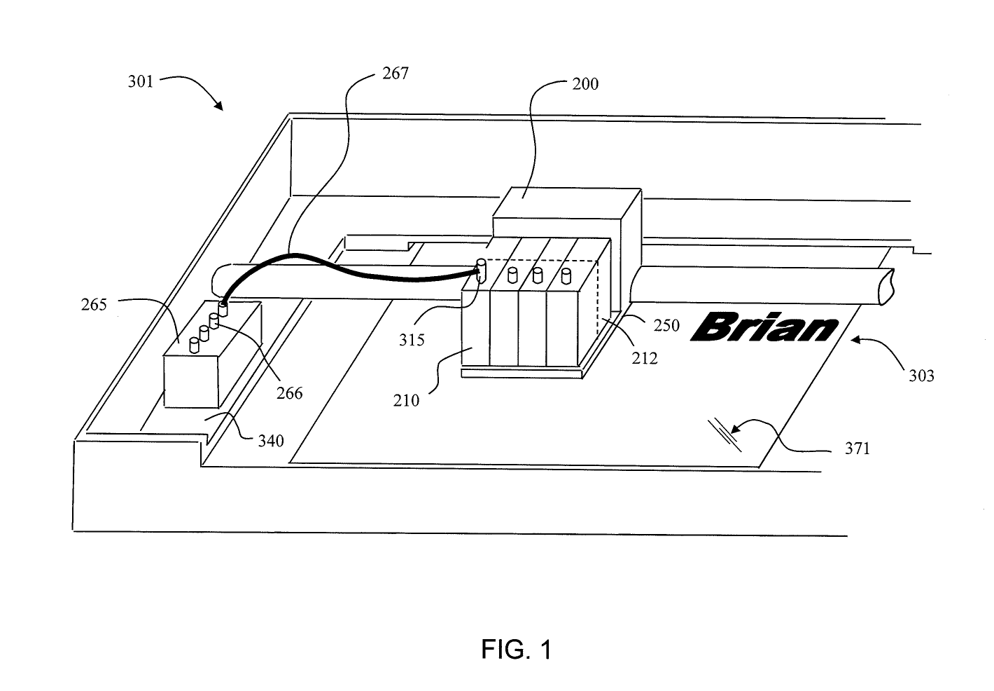

FIG. 1 is a perspective of an interior portion of an off-axis printer 301 according to an embodiment of the present invention. Although ink is shown in the preferred embodiment, any liquid is suitable for the present invention. An inkjet printhead 250 is disposed on a carriage 200 and includes at least one nozzle array (not visible from the view of FIG. 1) which directs ink droplets onto a recording medium 371. A primary ink supply 265 is rigidly mounted on a support base 340. The carriage 200 moves the printhead 250 back and forth across a print region 303 so that an image (such as letters “Brian”) can be printed on the recording medium 371. At least one pressure-regulated secondary ink supply 210 is mounted on the printhead 250 which moves in conjunction with the printhead 250. In this embodiment of FIG. 1, the primary ink supply 265 includes four ink supplies, each having a tubing connector 266, although the number of ink supplies can vary depending on the particular design. The tubing connectors 266 extend inside the primary ink supplies and can extend substantially to the bottom of primary ink supply 265 so that ink can continue to be withdrawn as it is depleted. Alternatively, in other configurations (not shown) tubing connectors 266 can be located near the bottom of primary ink supply 265, preferably when the primary ink supply 265 is located above the secondary ink supply 210 permitting gravity to transport the fluid. In the example of FIG. 1, a pump (not shown) is enclosed within the primary ink supply 265 for pumping the ink since the location of the primary ink supply 265 (at or below the elevation of its destination, secondary ink supplies 210) does not lend itself to gravitational flow.

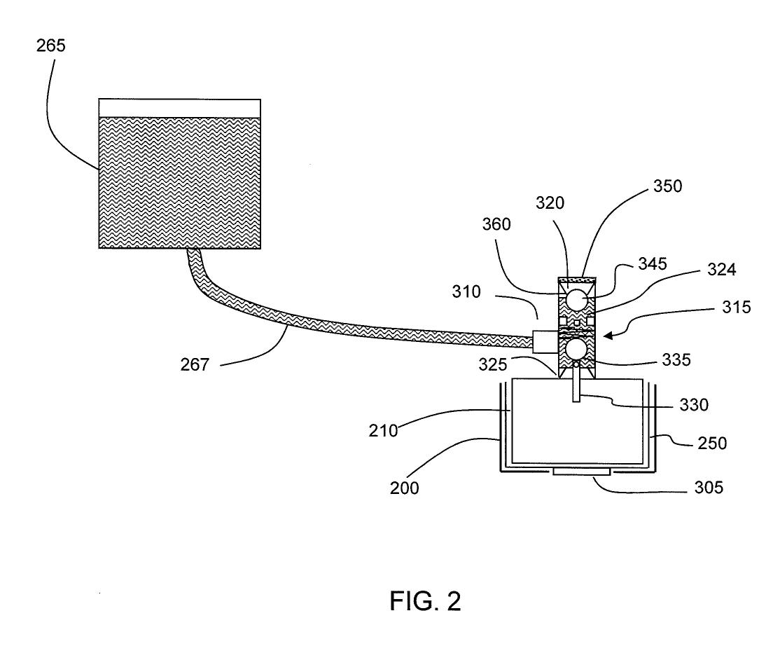

Four secondary ink supplies 210 each include a conduit 315 (see FIG. 2) and are mounted on the carriage 200 via the printhead 250 for supplying ink to printhead 250 so that the carriage 200 moves the secondary ink supplies 210 as well as the printhead 250. As ink is used during printing and maintenance processes, ink is passed from the primary ink supply 265 through flexible tubing 267, to the conduit 315 and eventually into the secondary ink supplies 210 for replenishing the secondary ink supplies 210. It is noted for clarity that only one piece of the flexible tubing 267 is shown in FIG. 1 so as not to obscure other features and that the details of the conduit 315 are omitted due to size constraints of FIG. 1, but are discussed in detail herein below.

A regulator chamber 212 is disposed extending into the secondary ink supply 210 for regulating the ink back pressure required by the ejector nozzles and in particular for damping out pressure spikes that occur as the carriage 200 is moved back and forth during printing. Pressure regulated secondary ink supply 210 can be integrated as part of printhead 250 or it can be detachable from printhead 250.

FIG. 2 is a schematic illustrating the inkjet printer according to an embodiment of the present invention. The flexible tubing 267 connects the rigidly mounted primary ink supply 265 to the carriage mounted secondary ink supply 210. The pressure regulator 212 (not shown in FIG. 2) is typically included with the secondary ink supply 210 to maintain the ink pressure within a satisfactory range. If the ink pressure at the nozzle array 305 becomes too high, ink can drool out of the nozzles. If the ink pressure at the nozzle array 305 becomes too low, the nozzles cannot be refilled quickly enough and printing defects can occur. Typically, pressure is maintained between around negative 2 inches and negative 10 inches of water.

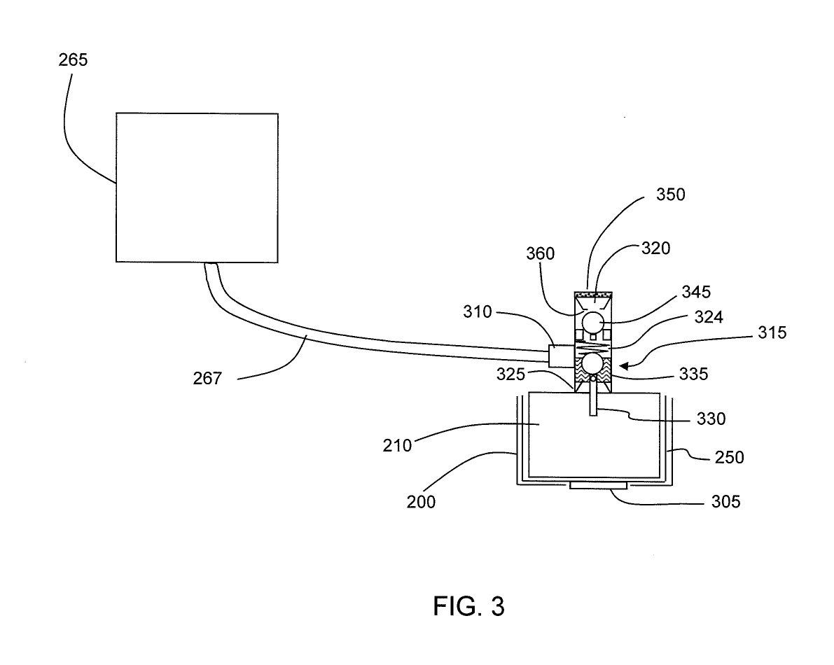

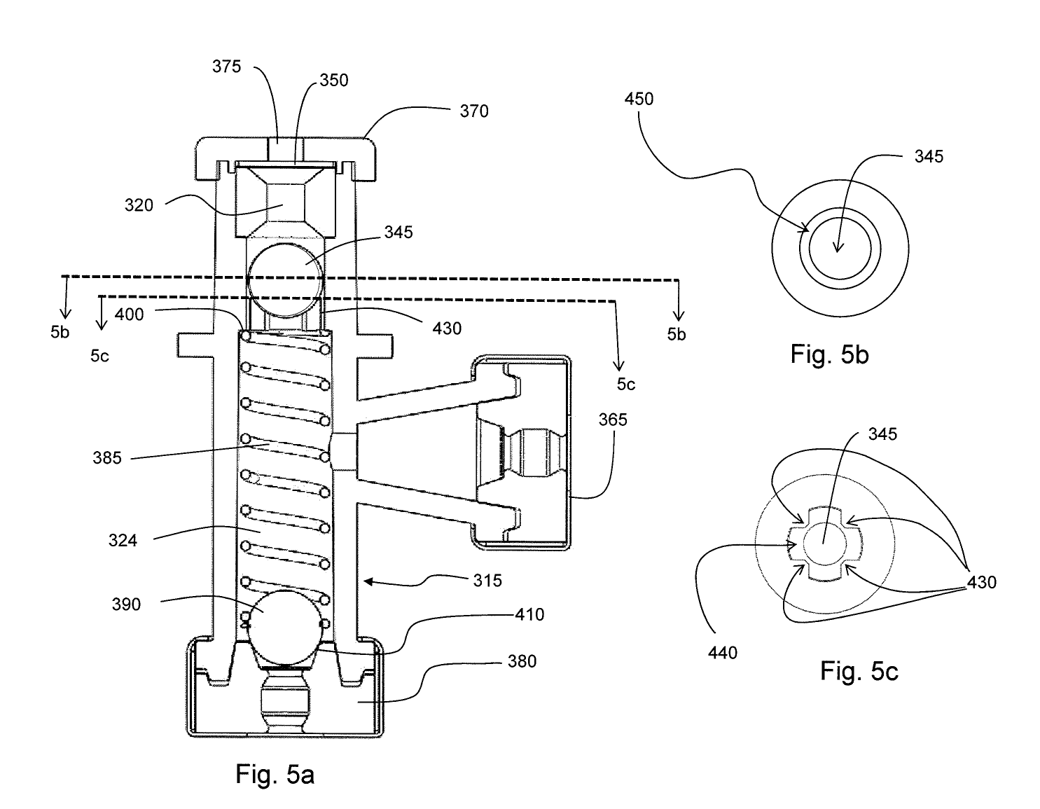

In the example of FIG. 2, the conduit 315 includes an inlet 310 attached to the tubing 267 for receiving the ink, an outlet 325 for passing the ink to the secondary ink supply 210, a vent 320 for venting gas (typically air) from the conduit 315 and an interior portion 324 for providing a passageway for the ink to flow from the inlet 310 to the outlet 325. It is noted that some of the components of the interior portion 324 are not discussed relative to FIGS. 2 and 3 since the scaled size of these components as shown in FIGS. 2 and 3 are small, but they are discussed later relative to FIG. 5. A hollow needle 330 is disposed within the secondary ink supply 210 and displaces the ball of a spring-loaded ball valve 335 in order to permit ink to flow into the secondary ink supply 210 as necessary. If the secondary ink supply 210 is removed, for example, in order to change the printhead 250, the ball valve 335 provides a seal so that ink does not drain out of the flexible tubing 267.

It is noted that the vent 320 is disposed above the inlet 310 and the outlet 325, and the vent 320 is covered with an air permeable membrane 350 which is included as a portion of the vent path. A movable element 345, such as a ball float (shown in this embodiment) a flap or other component capable of performing this function, is provided to inhibit the flow of gas (including air and water vapor from the ink) when the ink at the inlet 310 is at or above a predetermined threshold. In particular, if the ink level is high enough, as it usually will be during operation, the movable element 345 will be raised upwardly by the ink so that the movable element 345 seals against a sealing surface 360 that is below the air permeable membrane 350. This inhibits the loss of water vapor from the ink through the air permeable membrane 350. It is noted that, although a spherical ball float is shown, the ball float may be shaped as a cylinder, tapered cone, or any other shape as those skilled in the art can readily determine. It is noted that in the embodiment such as in FIG. 2 where the primary ink supply 265 is at a higher elevation than the secondary ink supply 210, the ink flows under the influence of gravity without the need for a pump.

FIG. 3 is similar to FIG. 2, but represents an instance where there is sufficient air in the flexible tubing 267 that the ink level in the interior portion 324 has dropped below a predetermined threshold. As a result the movable element 345, which floats atop of the ink in the case of a ball float, is no longer pressed against the sealing surface 360. As a result, air in the system (tubing 267 and conduit 315 having its inlet 310 and outlet 325) can escape through the vent 320. For example, when an empty primary ink supply 265 is replaced with a full supply, ink flows through the flexible tubing 267. The ink forces the air out of the flexible tubing 267 and subsequently out of the vent 320 and through membrane 350. In addition to reduced loss of volatiles such as water vapor, a second advantage of the ink transfer apparatus of FIGS. 2 and 3 is that as the ink comes through the flexible tubing 267 and displaces the air, ink is prevented from reaching the air permeable membrane 350 by the movable element 345, such as the ball float, which seals against the sealing surface 350 as the ink level is raised. Thus the air permeable membrane 350 remains dry so that it continues to be optimally effective for venting gas but not the passage of the ink.

The ball float 345 is designed such that it will float in the ink. In other words, if the ink has a density of approximately 1 gram per cubic centimeter (similar to water), the ball float 345 is designed to have a density of less than 1 gram per cubic centimeter. To achieve the desire density, the ball float 345 can be hollow and air filled for example.

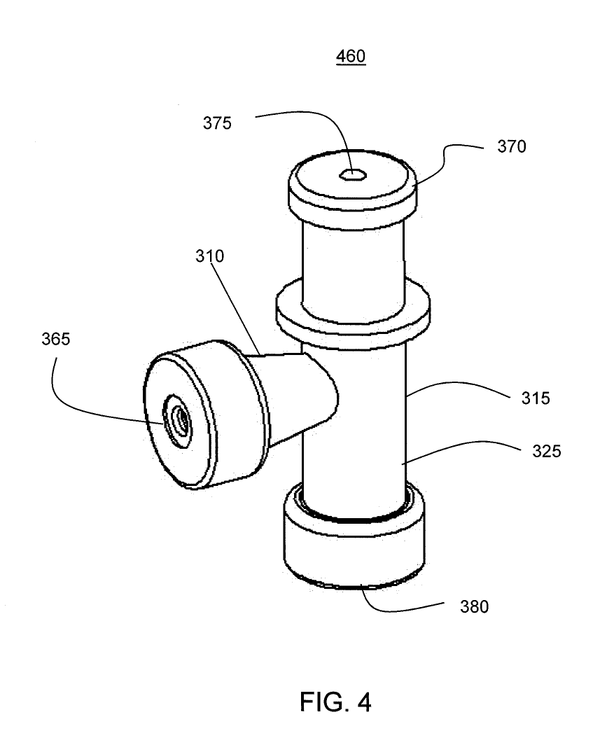

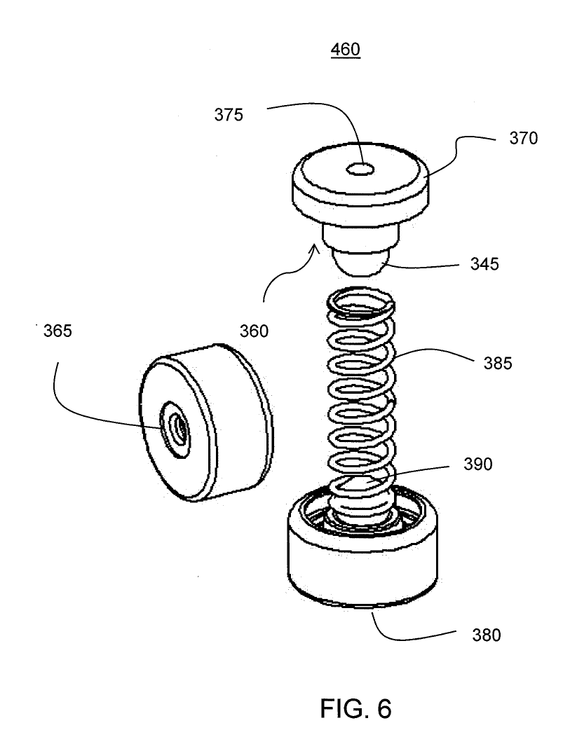

Referring to FIG. 4, there is shown the conduit 315 having the inlet 310 and the outlet 325. An inlet coupling 365 is attached to the inlet 310 for permitting the flexible tubing 267 (see FIGS. 1-3) to be attached to the inlet 310. A vent cap 370 having a vent opening 375 covers a top portion of the vent 320 and the air permeable membrane 350 (both of which are not visible in FIG. 4 due to being covered by the vent cap 370). An outlet coupling 380 is attached to the outlet 325 for permitting to be coupled to the secondary ink supply 210. For convenience, the entire apparatus as shown in FIG. 4 is referred as an ink transfer device 460 so that FIGS. 6 -9, in which parts are selectively omitted for illustrating various components more clearly, have a point of reference.

Referring to FIG. 5a, there is shown the interior portion 324 of the conduit 315 for illustrating the air flow when the ball float 345 is in its venting position and components in the lower part of the interior portion 324 for selectively permitting and inhibiting flow to the secondary ink supplies 210. A spring 385 and a sealing ball 390 function together to form the ball valve 335 (shown in FIGS. 2 and 3). The upper portion of the spring 385 rests against a lip 400 for inhibiting upwardly movement beyond the lip 400. The lower portion of the spring 385 rests against ball 390. In FIG. 5a, the needle 330 (see FIGS. 2 and 3) has not been inserted, and the sealing ball 390 is disposed on a sealing surface 410 for preventing ink to flow out of the interior portion 324. When the needle 330 is inserted, the sealing ball 390 moves upwardly with the force of the needle 330 and the force of this upwardly movement urges the lower portion of the spring 385 upwardly overcoming the spring force, and an ink passageway is formed for permitting the ink to flow around the sealing ball 390 and into the pressure regulated secondary ink supplies 210.

In the upper portion of the interior portion 324, the ball float 345 rests on feet 430, which are molded into the conduit 315. As best seen in FIG. 5c, notched-out openings 440 are formed so that the gas or air flows therethrough. As best seen in FIG. 5b, the ball float 345 (shown in cross section) at its largest diameter is disposed inside an upper portion of the conduit 315 and shows a sufficient air path 450 formed around the ball float 345. It is to be understood that when the ball float 345 is in the vent position as shown, gas (typically air) enters the inlet 310, passes into the interior portion 324, maneuvers through the open space of the spring 385, through the opening 440 and air path 450, out of the vent 320, through the air permeable membrane 350 and finally through the opening 375 in the vent cap.

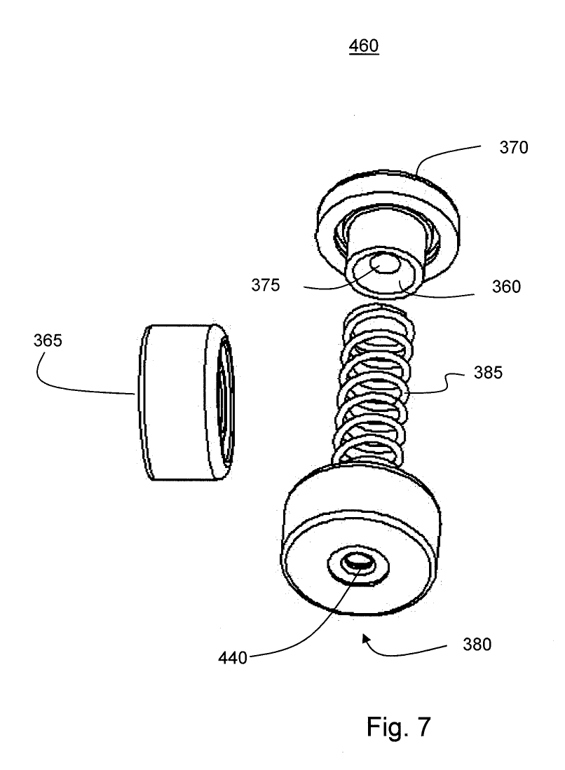

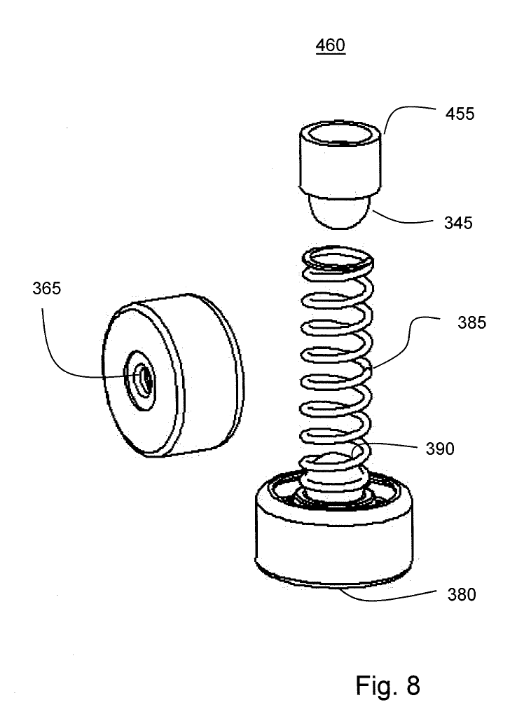

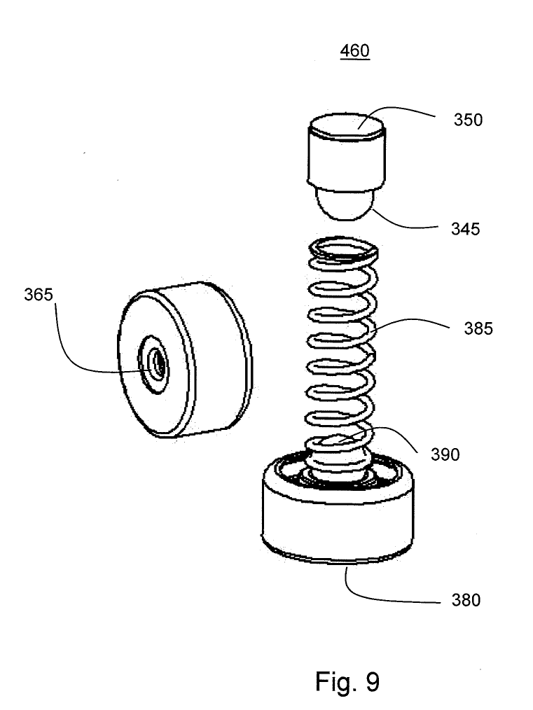

Referring to FIG. 6, the conduit 315 is removed so that the sealing position of the ball float 345 against the sealing surface 360 (hidden from view in FIG. 6) is more clearly shown. FIG. 7 is the same as FIG. 6 except that the view is altered and the ball float 345 is removed so that the sealing surface 360 is shown. The view of FIG. 7 also shows an opening 440 in the outlet coupling 380 for permitting the needle 330 to pass through the outlet coupling 380. FIG. 8 is the same as FIG. 6 except that the vent cap 370 is removed and the ball float 345 is installed so that a membrane seat 455 of the vent 320 can be seen. The membrane seat 455 forms a seat upon which is disposed the air permeable membrane 350 as seen in FIG. 9.

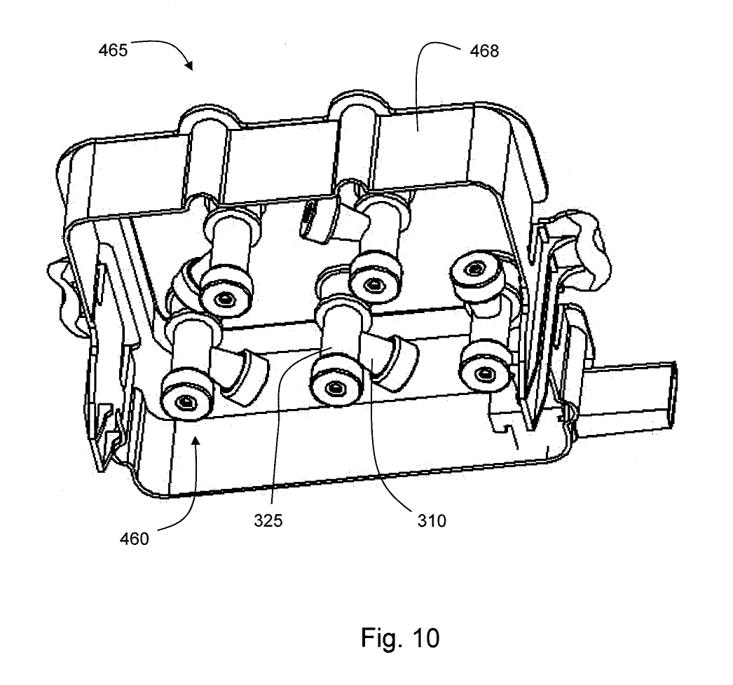

Referring to FIG. 10, there is shown an ink interface 465 that includes a plurality of ink transfer devices 460 that are supported by an ink interface housing 468. In this case, the ink is passed from the plurality of primary ink supplies 265 (as shown in FIG. 1) into a plurality of ink transfer devices 460 each having a conduit with an inlet 310; an outlet 325; and the vent 320 covered by an air permeable membrane 350 (not visible in FIG. 10). The flexible tubing 267 is used to connect the primary ink supplies 265 to each of the inlets 310. Each of the outlets 325 respectively connects to a plurality of secondary ink supplies (see FIG. 1).

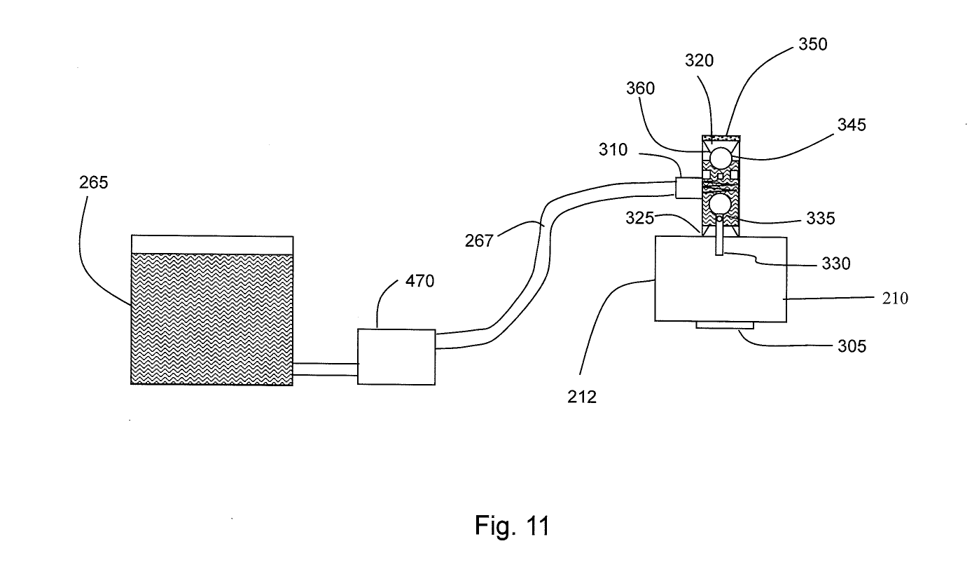

FIG. 11 is the same as FIGS. 2 and 3 except that the primary ink supply 265 is at an elevation at or lower than the elevation of the secondary ink supply 210 so that a pump 470 is connected to the flexible tubing 267 to pump the ink to the secondary ink supply 210.

The invention has been described in detail with particular reference to certain preferred embodiments thereof, but it will be understood that variations and modifications can be effected within the spirit and scope of the invention.

### PARTS LIST

200 carriage
210 secondary ink supplies
212 pressure regulator
250 printhead
265 primary ink supply
266 tubing connector
267 tubing
301 off-axis printer
303 print region
305 nozzle array
310 inlet
315 conduit
320 vent
324 interior portion
325 outlet
330 needle
335 ball valve
340 support base
345 movable element (ball float)
350 air permeable membrane
360 sealing surface
365 inlet coupling
370 vent cap
371 recording medium
375 vent opening
380 outlet coupling
385 spring
390 sealing ball
400 lip
410 sealing surface
420 disk

### PARTS LIST (CONTINUED)

430 feet
440 opening
450 air path
455 membrane seat
460 ink transfer device
465 ink interface
468 ink interface housing
470 pump

1. An apparatus for passing a liquid from a first location to a second location, the apparatus comprising:
a) a conduit having an inlet for receiving the liquid from the first location; and an outlet for passing the liquid to the second location; and a vent for permitting gas to be vented;
b) a membrane disposed covering the vent for permitting the venting of gas but not the passage of the liquid;
c) a movable element disposed in the conduit for selectively permitting and inhibiting flow of gas to the vent, wherein when liquid in the conduit is below a predetermined threshold, the movable device is placed at a venting position that allows free flow of gas to the membrane, and when the liquid in the conduit is at or above the predetermined threshold, the movable device is placed at a sealing position that does not allow free flow of liquid to the membrane.

2. The apparatus of claim 1, wherein the liquid includes water as at least one component.

3. The apparatus of claim 1 further comprising a valve disposed at the outlet.

4. The apparatus of claim 3, wherein the valve includes a ball and spring.

5. The apparatus of claim 1, wherein the liquid has a first density and the movable device includes a ball having a second density that is less than the first density.

6. The apparatus of claim 1, the conduit including a surface against which the movable device is configured to seal.

7. The apparatus of claim 1, wherein the first location is disposed higher than the second location so that liquid can pass to the second location under the influence of gravity.

8. The apparatus of claim 1 further comprising a pump that is configured to move liquid from the first location to the second location.

9. The apparatus of claim 1, wherein the vent is disposed in line with the outlet, and the inlet is disposed between the vent and the outlet.

10. The apparatus of claim 1, wherein the movable device is disposed between the inlet and the vent during at least a portion of operation.

11. An inkjet printing system comprising:
a primary ink supply;
a secondary ink supply that receives ink for an inkjet printer from the primary ink supply;
a conduit having an inlet for receiving the liquid from the primary ink supply; an outlet for passing the liquid to the secondary ink supply; and a vent for permitting gas to be vented; and
a movable element disposed between the inlet and the outlet for selectively permitting and inhibiting flow of gas to the vent, wherein when ink at the inlet is below a predetermined threshold, the movable element is placed at a venting position that allows flow of gas to the membrane, and when the ink at the inlet is at or above the predetermined threshold, the movable element is placed at a sealing position that does not allow flow of gas to the membrane.

12. The inkjet printing system of claim 11 further including:
a carriage for moving the secondary ink supply back and forth across a printing region; and
tubing to connect the primary ink supply with the inlet.

13. The inkjet printing system of claim 12 further including a plurality of primary ink supplies; a plurality of conduits each having a vent, inlet and outlet; a plurality of secondary ink supplies; and a plurality of tubes that respectively connect primary ink supplies with a corresponding inlet.

14. The inkjet printing system of claim 11 further including a pressure regulator to maintain the ink pressure at a printhead at an operating pressure that is different from an ink pressure in the primary ink supply.

15. The inkjet printing system of claim 11, wherein the ink includes a volatile component, and when the movable element is placed at the sealing position, flow of vapor of the volatile component of the ink to the vent is also inhibited.

16. The inkjet printing system of claim 11 further comprising a valve at the outlet.

17. The inkjet printing system of claim 16, wherein the valve includes a ball and spring.

18. The inkjet printing system of claim 11, wherein the ink has a first density, and the movable device includes a ball having a second density that is less than the first density.

19. The inkjet printing system of claim 11 further including a surface against which the movable device is configured to seal.

20. The inkjet printing system of claim 11, wherein the primary ink supply is disposed higher than the secondary ink supply so that ink can pass to the secondary ink supply under the influence of gravity.

21. The inkjet printing system of claim 11 further comprising a pump that is configured to move liquid from the primary ink supply to the secondary ink supply.

22. The inkjet printing system of claim 11, wherein the vent is disposed in line with the outlet, and the inlet is disposed between the vent and the outlet.

23. The inkjet printing system of claim 11, wherein the movable element is disposed between the inlet and the vent during at least a portion of operation.
